(19) United States
(12) Patent Application Publication
(10) Pub. No.: US 2004/0149722 A1
(43) Pub. Date: Aug. 5, 2004

(54) Cooking device

(75) Inventors: Wolfgang Schnell, Trostberg (DE); Klaus Dengler, Schonau (DE)

Correspondence Address: John T. Winburn, BSH Home Appliances Corporation, 100 Bosch Blvd, New Bern, NC, 28562, US

(73) Assignee: BSH Bosch und Siemens Hausgerate GmbH, Munich (DE)

(21) Appl. No.: 10/623,745

(22) Filed: Jul. 21, 2003

(30) Foreign Application Priority Data
Jan. 31, 2001 (DE) 10104501.8

(51) Int. Cl. H05B 3/68

(52) U.S. Cl. 219/460.1

(57) ABSTRACT

A cooking device having a retainer recess in a bottom wall of the cooking device muffle. A thermal radiation-permeable cover mounted to the recess and covering a radiant heat element arrangement. The cover seals the bottom wall with a raised edge at least on the sides and back wall of the cooking device muffle.

The invention relates to a cooking device with a cooking device muffle having a cooking chamber, which is limited inter alia by side walls and a rear wall and which can be closed by a cooking device door, which cooking device muffle has a retainer recess at the bottom, against which a thermal radiation-permeable cover rests, covering a radiant heat element arrangement that provides the cooking device with heat from below.

DE 35 39 880 A1 discloses a cooking device having a cooking device muffle. The cooking device has cooking oven heating arranged on the outside of a cooking oven muffle, which has a muffle mantle comprising two side walls, a bottom wall and a top wall as well as a rear wall closing the muffle at the back and an outwards directed collar on the open side. Identical heating can be provided, for example, on the underside of the bottom wall and on the top side of the top wall. Each heating source is arranged in the region of a panel-shaped radiation window or a cover, which is arranged parallel to the associated muffle wall, forms the majority of this muffle wall and can have outer edges parallel to this muffle wall. The wall sections attaching to the edge of each cover and substantially sealed by adhesion, for example, lie approximately in the plane of the inner surface of the cover and can be offset outwards comparatively slightly, that is, by less than the thickness of the cover.

The task of the invention is to provide a cooking device, in which the bottom wall of the cooking device muffle is effectively sealed against liquid by simple means.

This task is solved by the cooking device of Claim 1. According to the characterising part of Claim 1 the heat radiation-permeable cover is formed with an edge, upswept at least to the side walls and the rear wall of the cooking device muffle. Due to a cover designed thus liquid running out of the cooking dishes during the cooking process, or cleaning fluid running out during a cleaning procedure, is captured. The cover according to the present invention therefore creates a liquid collection area at the bottom, which effectively protects the bottom wall from liquid accumulation.

In an embodiment of the invention the cover inside the upswept edge has at least one tub-shaped collection area. Accumulation of liquid is therefore concentrated particularly on this collection area. The cover can thus have fluid or angular junctions between the upswept edge and the collection area.

Since the upswept edge projects over the level of the liquid collecting in the cover, the latter remains virtually dry. It is therefore advantageous to bring the cover by means of its upswept, almost dry edge to bear against a retainer recess of the cooking device muffle, as a special liquid seal between the edge and the retainer recess is not necessary there. At the same time it is guaranteed that no liquid runs out from between the upswept edge and the now attached retainer recess. So that the liquid level in the tub-like cover definitely remains below the edge of the cover, a height of 3 to 5 cm of the edge starting out from a floor side of the collection area has proven to be particularly advantageous.

In comparison to the prior art liquid accumulation forming on the connecting area between the cover and the retainer recess can be prevented in this way. A costly liquid seal between the retainer recess of the cooking device muffle and the cover, which for this purpose still withstands high temperatures during cooking or pyrolytic self-cleaning, can therefore be dispensed with. According to the present invention it suffices to use a seal with only a heat-insulation effect in the abovementioned connecting area, which does not have to have any additional liquid-sealing effect. Such a seal can be made from fibreglass, for example. To ensure effective protection of the seal against liquid a minimal height of approximately 2 to 5 cm from the top side of the collection area of the cover has proven beneficial.

It is also of advantage to use the front surface of the upswept edge of the cover as a bearing surface for the seal, which is thus arranged between this bearing surface and the retainer recess. The seal can thereby cushion the bearing forces exerted by the cooking device muffle on the front surface of the upswept edge and thus prevent damage to the edge area of the cover.

When using a cover with minimal material thickness this front bearing surface for the seal cannot be big enough. In such a case it is an advantage to provide the upswept edge with an angular section. This angular section can provide a bearing surface for the seal instead of the front surface of the cover. The dimensions of the angled section can be such that the desired bearing surface is provided for the seal.

According to an embodiment the entire bottom wall of the cooking device muffle is made up by the glass ceramic cover. The bottom wall of the muffle is thus provided with a smooth inner surface entirely without edges or junctions. Cleaning the bottom wall is thus considerably simplified and at the same time the danger of injury during cleaning due to protruding edges is eliminated. The cover is effectively formed with an edge upswept only to the side walls and the rear wall of the cooking device muffle. On the front supply opening of the muffle by comparison the cover has no upswept edge so as not to obstruct access through the supply opening of the cooking device muffle into the cooking chamber.

However, so that liquid can be prevented from running out in the front area of such a cover, said cover can be provided with an additional depression, offset from the floor of the cover. Alternatively or in addition to this depression a draining channel can be arranged under the front area of the cover, in which liquid, running off the cover, is collected.

Two embodiments of the invention are described hereinbelow with reference to the attached figures, in which:

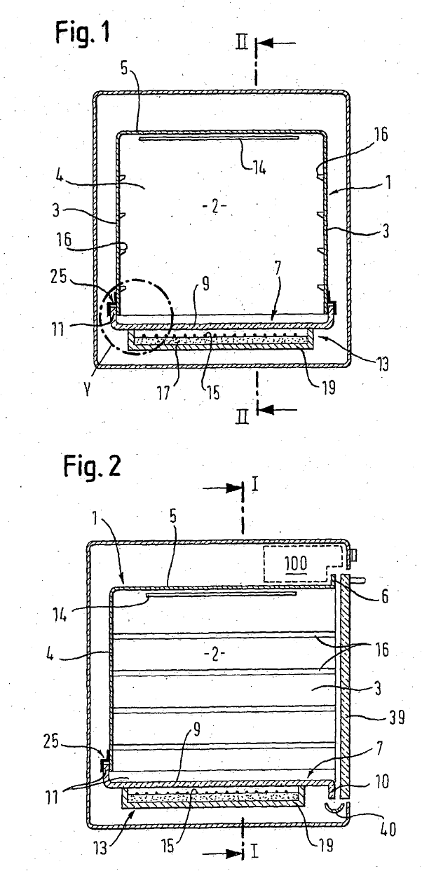

FIG. 1 is a front elevation of a cooking device according to a first embodiment in vertical section along line I-I of FIG. 2;

FIG. 2 is a side elevation of the cooking device in vertical section along line II-II of FIG. 1;

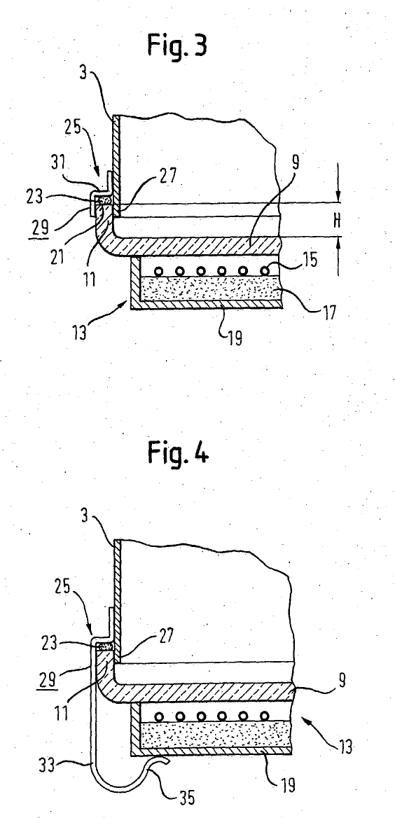

FIGS. 3 to 6 are enlarged sectional views of mounting sections for taking up a glass ceramic cover;

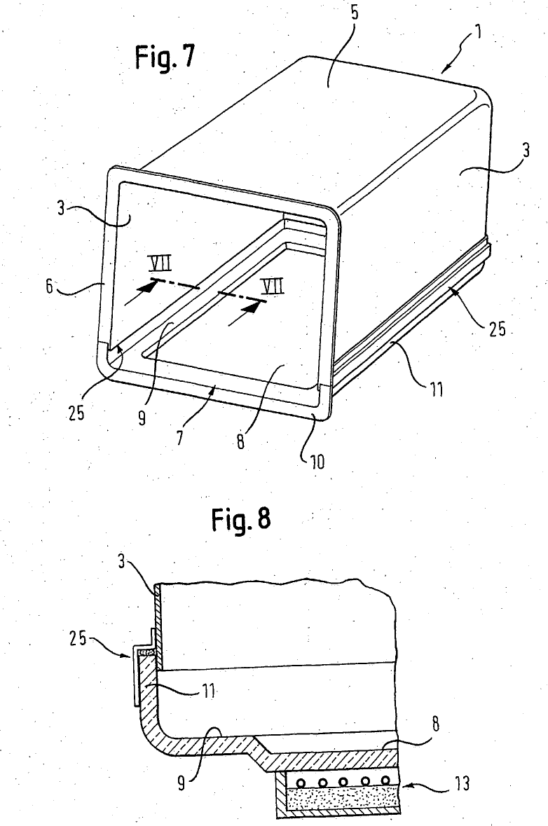

FIG. 7 is a perspective view of a cooking device muffle according to a second embodiment; and

FIG. 8 is an enlarged sectional view along line VII-VII of FIG. 7.

FIGS. 1 and 2 illustrate a cooking device with a housing, in which a cooking device muffle 1 according to the first embodiment and a control unit 100 with operating knobs indicated by dashed lines are arranged. The cooking device muffle 1 is sheathed for thermal radiation in insulating material, not shown here. A cooking chamber 2 of the cooking device muffle 1 can be closed on the front side by a pivoting cooking device door 39 shown in FIG. 2. The cooking chamber 2 is delimited by side walls 3, a rear wall 4, a top wall 5 and a bottom wall 9. In addition, insertion guides 16 are provided in known fashion on the side walls 3 of the cooking device muffle 1, so that cooking tray mountings can be pushed into the cooking chamber 2 of the cooking device muffle 1. As an alternative to the illustrated pivoting cooking device door 39 a cooking trolley with associated trolley door can also be provided. In this case instead of the insertion guides 16 hooked rails, attached to the cooking trolley door, can be used for mounting the cooking trays.

As shown in FIG. 1, a heat element arrangement 14 providing heat from above is mounted on the top wall 5 of the cooking device muffle 1. This heat element arrangement 14 is primarily a conventional tubular heat element. Alternatively, the heat element arrangement 14 for example can also be designed as a heat element arrangement. Lying opposite the heat element arrangement 14 on the bottom wall 9 is a heat element arrangement 13, providing heat from below.

The heat element arrangement 13 has a heat element housing 19, in which an insulation element 17 is arranged. Embedded in the insulation element 17 is a band heat conductor 15 as a heat radiation element from below. The peripheral edge of the heat element housing 19 is adhered for example by means of a silicone adhesive with a heat radiation-permeable cover 7, for example a glass ceramic cover. As evident from FIGS. 1 and 2, the cover 7 of the heat element arrangement 13 is for example formed by a deep draw process with an edge 11 upswept to the side walls 3 and the rear wall 4 of the cooking device muffle 1. At the same time the edge 11 is upswept approximately at right angles from a tub base of the cover 7. The tub base forms the whole bottom wall 9 of the cooking device muffle 1 and at the same time serves as a liquid accumulation area. The height H of the edge 11 shown in FIG. 3 is preferably. 3 to 5 cm starting out from the top side of the tub base. 9. Liquid or cleaning fluid dripping from the cooking material is collected in the collection area formed by the tub base 9, for example.

As is further evident form FIG. 2, the cover 7 is not provided in the region of the supply opening of the cooking chamber 2 with an upswept edge. Rather, a collar 10, extending at a right angle to the tub base 9 and the edge 11 to the outside of the cover 7, attaches both to the edge 11 and to the tub base 9. The collar 10 forms part of a muffle flange 6 framing the supply opening of the cooking chamber 2, as indicated in FIG. 7.

According to FIG. 2 a draining channel 40 is arranged underneath the collar 10 and also the cooking device door 39. Thereby, liquid, which runs from the tub base 9 of the cover 7 over its collar 10, is collected in the draining channel 40 and does not come into contact with for example the thermal radiation means of the cooking device arranged outside the cooking device muffle 1.

Mounting of the cover 7 on the cooking device muffle 1 is explained with reference to the unit Y from FIG. 1 shown on an enlarged scale in FIG. 3. The cooking device muffle 1 has a retainer recess 25, on which the edge 11 of the cover 7 rests. According to the figures the retainer recess 25 is formed on the side walls 3 and the rear wall 4 and has a grooved retainer, open on the bottom side, in which the upswept edge 11 is mounted. The bracket section 24 comprises an end flange 27 of the side walls 3 or the rear wall 4, and also comprises a separate profiled section 29. According to FIG. 3 the separate profiled section 29 is a double angle profile, which forms a profiled bracket 31 between two offset and parallel legs. One of these offset legs is attached to the side wall 3 or the rear wall, while the other forms the grooved retainer, open at the bottom, for the edge 11 of the cover 7, together with the end leg 27 of the side wall 3. Arranged between the profiled bracket 31 and a front surface 21 of the glass cover 7 as thermal radiation is a seal 23, made from fibreglass, for example. The seal 23 is arranged at a minimal height of approximately 2 to 5 cm from the top side of the tub base 9.

In FIG. 4 the separate profiled section 29 is designed differently to that shown in FIG. 2. Accordingly, the leg of the profiled section 29 forming the grooved retainer, open at the bottom, for the edge 11 of the cover 7, is lengthened and forms a retaining arm 33, which fastens under the heat element housing 19. To ensure simple mounting, the retaining arm 33 has a spring-loaded section 35, which uses spring force to press the edge 11 of the cover 7 into the grooved retainer, open at the bottom, of the retainer recess 25. The retaining arm 33 formed on the profiled section 29 and the spring-loaded section 35 can also be applied selectively to the retainer recesses 25 illustrated in the other figures.

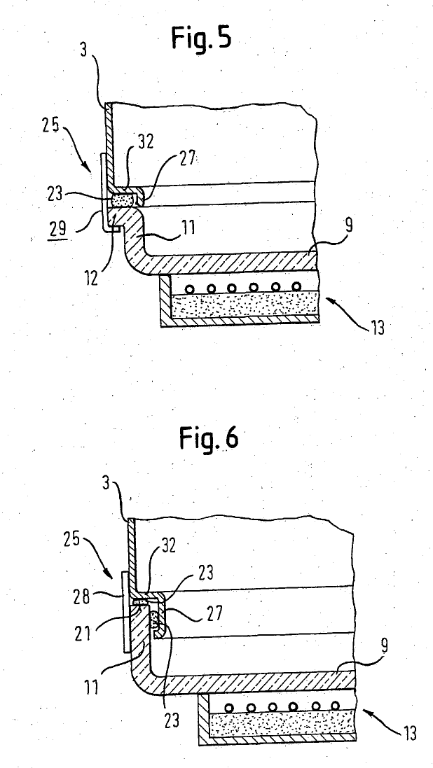

In FIG. 5 an additional angular section 12, which runs substantially offset and parallel to the flat tub base 9, is formed on the edge 11 of the cover 7. The angular section 12 creates an enlarged bearing surface for the seal 23, as compared to the front surface 21 in FIGS. 3 and 4. Further to this, a bearing shoulder 32 stepped into the cooking chamber 2 is formed on the side wall 3. At the same time the seal 23 is positioned between the bearing shoulder 32 and the angular section 12. On the bearing shoulder 32 the end leg 27 continues parallel to the side wall 3 and approximately in a plane with the inside of the edge 11 of the cover 7, and terminates almost flush with the latter. The result of this is that in the floor region of the cooking device muffle 1 there are no protruding edges, on which waste material could accumulate. This makes cleaning easier and eliminates the danger of injury from protruding edges. The separate profiled section 29 shown in FIG. 5 is L-shaped. A leg of the L-shaped profiled section 29 is connected to the outside of the side wall 3, while the other leg of the L-shaped profile fastens on to the underside of the angular section 12.

Another embodiment of a retainer recess 25 is illustrated in FIG. 6. Here, according to FIG. 6 two seals 23 are arranged between the edge 11 of the cover 7 and the retainer recess 25 to improve thermal radiation. The first seal 23 is arranged between the bearing shoulder 32 of the side wall 3 and the front surface 21 of the cover 7. By comparison the second seal 23 is arranged between the end leg 27 and the inner side of the edge 11.

FIG. 7 illustrates a cooking device muffle 1 according to a second embodiment in perspective. As in the first embodiment the illustrated cooking device muffle 1 is delimited by the side walls 3, the rear wall 4 and the top wall 5. The cooking device muffle 1 also has a retainer recess 25 at the bottom, on which the upswept edge 11 of the cover 7 rests. Also, the collar 10 attaches to the edge 11 and to the tub base 9 in the region of the supply opening of the cooking chamber 2. The collar 10 thus forms a part of the muffle flange 6 of the cooking device muffle, which frames the supply opening of the cooking chamber 2 and which can be brought into contact with the cooking device door 39 via a seal, not illustrated here.

In contrast to the first embodiment, as shown in the enlarged detail VII in FIG. 8, the flat tub base 9 of the cover 7 merges into a depression 8 via a flank. The depression 8 is offset downwards to the tub base 9 and extends parallel to the tub base 9. The depression 8 creates an additional collection area in the tub base 9, which prevents liquid from running over the collar 10 out of the cooking chamber 2.

1. A cooking device with a cooking device muffle (1) having a cooking chamber (2), which is delimited inter alia by side walls (3) and a rear wall (4) and can be closed by a cooking device door (39), which cooking device muffle (1) has a retainer recess (25) at the bottom, against which a for thermal radiation-permeable cover (7) rests, which covers a heat element arrangement (13) providing the cooking device with heat from below, characterised in that the cover (7) is formed with an edge (11), upswept at least to the side walls (3) and the rear wall (4) of the cooking device muffle (1).

2. The cooking device as claimed in claim 1, characterised in that the cover (7) inside the upswept edge (11) has at least one tub-shaped collection area (8, 9).

3. The cooking device as claimed in any one of claims 1 or 2, characterised in that the upswept edge (11) is mounted in the retainer recess (25).

4. The cooking device as claimed in any one of the foregoing claims, characterised in that the height (H) of the edge (11) going from the top side of the collection areas (8, 9) is 3 to 5 cm.

5. The cooking device as claimed in any one of the foregoing claims, characterised in that at least one seal (23) is arranged between the upswept edge (11) and the retainer recess (25).

6. The cooking device as claimed in claim 5, characterised in that the seal (23) is a fibreglass seal.

7. The cooking device as claimed in claim 5 or 6, characterised in that the seal (23) is arranged at a minimal height of approximately 2 to 5 cm from the top side (9) of the collection area (7).

8. The cooking device as claimed in any one of claims 5 to 7, characterised in that the seal (23) is arranged between a front surface (21) of the upswept edge (11) and the retainer recess (25).

9. The cooking device as claimed in any one of claims 5 to 8, characterised in that the upswept edge (11) has an angular section (12) and in that the seal (23) is arranged between the angular section (12) and the retainer recess (25).
